(19) United States
(12) Patent Application Publication
(10) Pub. No.: US 2021/0251451 A1
(43) Pub. Date: Aug. 19, 2021

(54) CLEANER AND CONTROL METHOD THEREOF

(71) Applicant: LG Electronics Inc., Seoul (KR)

(72) Inventors: Moohyun KO, Seoul (KR); Namil WOO, Seoul (KR); Kookhaeng LEE, Seoul (KR); Kihong PARK, Seoul (KR)

(21) Appl. No.: 17/178,668

(22) Filed: Feb. 18, 2021

(30) Foreign Application Priority Data
Feb. 18, 2020 (KR) 10-2020-0019889

(51) Int. Cl. A47L 9/28; A47L 11/40

(52) U.S. Cl. CPC A47L 9/2842; A47L 9/281; A47L 11/4011; A47L 11/4041

(57) ABSTRACT

A cleaner includes a cleaner main body including a suction motor and a handle, and a suction nozzle that is connected to the cleaner main body and includes a housing that defines an open portion at a lower portion, a rotary cleaning unit disposed inside the housing and exposed through the open portion of the housing, and a support member that is located below the housing and supports the housing and has an open interior and at least one sub-inlet that is defined at a front surface of the support member and configured to receive foreign substances. The cleaner includes a controller disposed at the cleaner main body and configured to determine a condition of the surface by driving an artificial intelligence engine, and open and close the at least one sub-inlet based on the condition of the surface to thereby adjust a suction force of the cleaner.

### CROSS-REFERENCE TO RELATED APPLICATIONS

This application claims the priority benefit of Korean Patent Application No. 10-2020-0019889, filed on Feb. 18, 2020, in the Korean Intellectual Property Office, the disclosure of which is incorporated herein by reference.

### TECHNICAL FIELD

The present disclosure relates to a cleaner and a control method thereof, and more particularly, to a structure for controlling a suction force of a cleaner depending on a floor condition by using artificial intelligence and a control method thereof.

### BACKGROUND

Vacuum cleaners are devices that can suction dust and air by using a suction force generated by a suction motor mounted inside a cleaner main body, separate dust from air, and collect the dust.

The cleaners can be classified into a manual cleaner that can be moved by a user for cleaning, and a robot cleaner that can travel by itself for cleaning. In addition, manual cleaners may be classified into canister cleaners, upright cleaners, stick cleaners, handy cleaners, and robot cleaners. The canister cleaner can include a cleaner main body and a suction nozzle provided separately from the cleaner main body, where the cleaner main body and the suction nozzle are connected to each other by a connection device. The upright cleaner can include a suction nozzle rotatably connected to a cleaner main body. The stick cleaner and the handy cleaner may be used in a state in which a user is holding the cleaner main body by hand.

In some cases, the stick cleaner can include a suction motor disposed close to the suction nozzle (lower center), and the handy cleaner can include a suction motor disposed close to a holding part (upper center). The robot cleaner can perform self-cleaning while traveling by itself through an autonomous traveling system.

The suction nozzle may touch a floor and directly suction dust and air. The suction force generated by the suction motor mounted inside the cleaner main body may be transmitted to the suction motor, and dust and air may be suctioned into the suction nozzle by the suction force.

In some cases, a rotary cleaning unit (or agitator) may be installed on the suction nozzle. The rotary cleaning unit can improve cleaning performance by scraping off dust from the floor or carpet while rotating. In some cases, a brush may be attached to the rotary cleaning unit.

A front case of the suction nozzle housing the rotary cleaning unit may be opened at the bottom to suction dust from the floor or carpet, and the suction nozzle can include a lower case that has an opened bottom, that is coupled with the front case, and that is disposed at the bottom of the suction nozzle.

In some cases, when suctioning dust into the open region, the suction force may be weakened depending on the floor condition. For example, when the floor is a carpet or the like, the suction force can be lowered due to clogging of the open region with the fibers of the carpet.

In some cases, a cleaner can open a valve for adjusting an angle when an intake port is clogged with fibers or the like. For instance, the cleaner can adjust the angle when the suction force is weakened in a nozzle head without taking the floor condition into comprehensive account.

In some cases, where a sub-inlet for suctioning large dust and the like is formed in a front buffer of the lower case, the sub-inlet may be used for suction of large foreign substances, but the sub-inlet can decrease the overall suction force and cause performance degradation.

The reduction in the suction force may not have a significant effect when the floor surface is on the hard floor. In some cases, however, when a surface pressure is low due to poor adhesion force to the floor, such as carpet, the reduction of the suction force by the sub-inlet may have a significant effect since the surface pressure may be further reduced on such a floor.

### SUMMARY

The present disclosure describes a cleaner including a cover configured to cover a sub-inlet, where the cover is controlled to be opened and closed depending on a floor condition.

The present disclosure further describes a cleaner that can move the cover downward to close the sub-inlet and that can automatically control the opening and closing of the cover depending on the floor condition. For example, the cleaner can include a motor and a plurality of gear structures for physically moving the cover by driving the motor.

The present disclosure further describes a cleaner that can control the opening and closing of the cover by being connected to the plurality of gear structures. In some examples, the floor condition can be generally divided into a hard floor, such as a tile, with a smooth surface, and a soft floor, such as a carpet, which has poor adhesion force to the floor surface due to fibers.

The present disclosure further describes a method for calculating a probability of a current floor condition by comprehensively reviewing a plurality of parameters through an artificial intelligence machine learning engine, rather than a manual switching from a user or a switching based only on in a load change, in opening and closing the cover depending on the floor condition.

The present disclosure further describes a cleaner that can periodically determine a floor condition and adjust a suction force based on the determination.

According to one aspect of the subject matter described in this application, a cleaner includes a cleaner main body including a suction motor disposed inside the cleaner main body and a handle disposed at an outside of the cleaner main body, and a suction nozzle that is connected to the cleaner main body and includes a housing that defines an open portion at a lower portion of the housing, a rotary cleaning unit disposed inside the housing and exposed through the open portion of the housing, the rotary cleaning unit being configured to clean a surface based on rotating relative to the surface, and a support member that is located below the housing and supports the housing and has an open interior and at least one sub-inlet that is defined at a front surface of the support member and configured to receive foreign substances. The cleaner further includes a controller disposed at the cleaner main body, the controller being configured to determine a condition of the surface by driving an artificial intelligence engine, and open and close the at least one sub-inlet based on the condition of the surface to thereby adjust a suction force of the cleaner.

Implementations according to this aspect can include one or more of the following features. For example, the cleaner can include a rotating motor disposed in the housing and configured to rotate the rotary cleaning unit, and the controller can be configured to receive an output current of the rotating motor, and determine the condition of the surface by driving the artificial intelligence engine based on the output current. In some implementations, the controller can be configured to determine a suction force value corresponding to at least one floor condition by driving the artificial intelligence engine through a suction force calculation model based on an operation command of a user and an output current of a rotating motor configured to rotate the rotary cleaning unit.

In some implementations, the controller includes suction force calculation models corresponding to a hard floor and a soft floor, respectively, and the controller is configured to determine suction force values corresponding to the hard floor and the soft floor by driving the suction force calculation models. In some implementations, the controller includes suction force calculation models corresponding to a hard floor and a soft floor, and the controller is configured to determine suction force values corresponding to the hard floor and the soft floor by driving the suction force calculation models, compare current suction force information including the suction force to the suction force values, and, based on comparing the current suction force information to the suction force values, determine a first probability that the condition of the surface corresponds to the hard floor and a second probability that the condition of the surface corresponds to the soft floor.

In some examples, the controller can be configured to close the at least one sub-inlet based on the second probability of the soft floor being greater than the first probability of the hard floor. In some examples, the controller can be configured to apply an output voltage of a battery of the cleaner as a variable to the suction force calculation models to determine the suction force values corresponding to the hard floor and the soft floor.

In some implementations, the controller can include suction force calculation models corresponding to a hard floor and a soft floor, where the suction force calculation models are different from each other. The controller can be configured to determine suction force values corresponding to the hard floor and the soft floor by driving the artificial intelligence engine through the suction force calculation models based on an operation command of a user and an output current of a rotating motor configured to rotate the rotary cleaning unit.

In some implementations, the controller can include suction force calculation models corresponding to a hard floor and a soft floor, where the suction force calculation models are different from each other. The controller can be configured to determine a condition function by driving the artificial intelligence engine based on an operation command of a user and an output current of a rotating motor configured to rotate the rotary cleaning unit, and determine suction force values corresponding to the hard floor and the soft floor by applying the condition function and a battery voltage to each of the suction force calculation models.

In some examples, the controller can be configured to determine the suction force values corresponding to the hard floor and the soft floor by changing reference values of the suction force calculation models according to the battery voltage. In some implementations, the support member can include a cover part configured to open and close the at least one sub-inlet based on a control command of the controller.

According to another aspect, a control method controls operation of a cleaner that includes a housing that defines an open portion at a lower portion of the housing, and a rotary cleaning unit that is disposed inside the housing, that is exposed through the open portion of the housing, and that is configured to clean a surface based on rotating relative to the surface. The control method includes obtaining a plurality of detection signals of the cleaner, determining a condition of the surface by driving an artificial intelligence engine based on the plurality of detection signals, and adjusting a suction force of the cleaner by opening and closing at least a part of the lower portion of the housing according to the condition of the surface.

Implementations according to this aspect can include one or more of the following features. For example, the housing can define at least one sub-inlet at a front surface of the lower portion of the housing, and the cleaner can include a cover part that is configured to open and close the at least one sub-inlet. In some examples, adjusting the suction force can be performed by controlling the cover part to open or close the at least one sub-inlet. In some examples, determining the condition of the surface can include receiving an output current of a rotating motor that is disposed in the housing and configured to rotate the rotary cleaning unit, and determining the condition of the surface based on the output current of the rotating motor.

In some implementations, determining the condition of the surface can include receiving an operation command of a user and an output current value of a rotating motor configured to rotate the rotary cleaning unit, determining a suction force value corresponding to at least one floor condition by driving a suction force calculation model based on the operation command of the user and the output current value of the rotating motor, comparing current suction force information including the condition of the surface to the suction force value, and, based on comparing the current suction force information to the suction force value, determining a first probability that the condition of the surface corresponds to a hard floor and a second probability that the condition of the surface corresponds to a soft floor.

In some examples, adjusting the suction force includes closing the at least one sub-inlet by moving the cover part downward based on the second probability of the soft floor being greater than the first probability of the hard floor.

In some implementations, determining the condition of the surface can include determining suction force values corresponding to a hard floor and a soft floor, respectively, by driving the artificial intelligence engine through a hard floor suction force calculation model and a soft floor suction force calculation model. In some implementations, determining the condition of the surface can include applying an output voltage of a battery of the cleaner as a variable to suction force calculation models, and driving the artificial intelligence engine through the suction force calculation models to determine suction force values corresponding to a hard floor and a soft floor.

In some implementations, determining the condition of the surface can include determining a condition function by driving the artificial intelligence engine based on an operation command of a user and an output current of a rotating motor configured to rotate the rotary cleaning unit, and determining suction force values corresponding to a hard floor and a soft floor by applying the condition function and a battery voltage to each of suction force calculation models, the suction force calculation models being different from each other. In some examples, determining the condition of the surface can further include changing reference values of the suction force calculation models according to the battery voltage to determine the suction force values corresponding to the hard floor and the soft floor.

### BRIEF DESCRIPTION OF THE DRAWINGS

FIG. 1 is a perspective view showing an example of a vacuum cleaner.

FIG. 2 is a perspective view showing an example of a suction nozzle of FIG. 1.

FIG. 3 is a top view showing the suction nozzle of FIG. 2.

FIG. 4 is a bottom view showing the suction nozzle of FIG. 1.

FIG. 5 is an exploded perspective view showing the suction nozzle of FIG. 1.

FIG. 6 is a cross-sectional view showing the suction nozzle cut along I-I′ of FIG. 4.

FIG. 7 is a cross-sectional view showing the suction nozzle cut along II-II′ of FIG. 4.

FIGS. 8A and 8B are a perspective view and a part of a bottom view illustrating an example of a lower frame of a suction nozzle.

FIGS. 9A and 9B are conceptual diagrams illustrating an example of covers of sub-inlets and a driving module thereof

FIG. 10 is a block diagram illustrating an example of a controller for controlling covers of a cleaner.

FIG. 11 is a flowchart illustrating an example method for controlling a cover of a cleaner.

FIG. 12 is a flowchart illustrating an example method for determining a floor condition of FIG. 11.

FIGS. 13A and 13B are schematic diagrams illustrating examples of movement of a cover according to the control method of FIG. 10.

FIGS. 14A to 14D are conceptual diagrams illustrating example operations of a driving module for moving a cover according to the control method of FIG. 10.

FIG. 15 illustrates a simulation result showing an example result of determining the floor condition according to FIG. 11.

### DETAILED DESCRIPTION

In the following description, although expressions designating directions such as “front,” “rear,” “left,” “right,” “up,” and “down” to be mentioned below are defined as indicated in the drawings, these are simply given to explain the present disclosure for clear understanding, and it is obvious that the respective directions can be defined in different ways depending on the reference point.

For example, the front can refer to a main traveling direction of the cleaner or a main traveling direction of a pattern traveling of the robot cleaner. Here, the main traveling direction can refer to a vector sum value of directions traveling within a predetermined time.

The use of terms with the expression “first,” “second,” etc. in front of the elements mentioned below is only used to avoid confusion of the elements, and is not related to the order, importance, or master/slave relationships between elements, or the like. For example, an implementation can only a second element without a first element.

In the drawings, the thickness or size of each element is exaggerated, omitted, or schematically illustrated for convenience and clarity of description. Furthermore, the size and area of each element do not fully reflect the actual size or area.

In addition, angles and directions mentioned in the process of describing a structure of the present disclosure are based on those described in the drawings. In the description of the structure in the specification, when the reference point and the positional relationship with respect to the angle are not clearly mentioned, reference will be made to the related drawings.

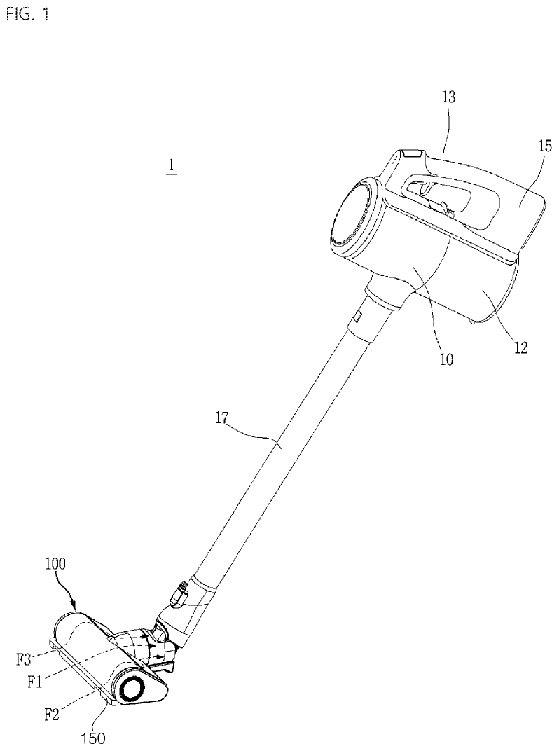

FIG. 1 is a perspective view illustrating an example of a vacuum cleaner.

Referring to FIG. 1, a vacuum cleaner 1 can include a cleaner main body 10 having a suction motor therein for generating a suction force, a suction nozzle 100 for suctioning in air containing dust, and an extension pipe 17 for connecting the cleaner main body 10 and the suction nozzle 100.

In some example, the suction nozzle 100 can be directly connected to the cleaner main body 10 without the extension pipe 17.

The cleaner main body 10 can include a dust container 12 in which dust separated from air is stored. Accordingly, dust introduced through the suction nozzle 100 can be stored in the dust container 12 through the extension pipe 17.

A handle 13 to be held by a user can be provided outside the cleaner main body 10. The user can perform cleaning while holding the handle 13.

A battery can be provided in the cleaner main body 10, and a battery accommodating part 15 in which the battery is accommodated can be provided in the cleaner main body 10. The battery accommodating part 15 can be provided under the handle 13. The battery can be connected to the suction nozzle 100 to supply power to the suction nozzle 100.

A control module can be inserted into the cleaner main body 10 as described above, and the control module can be embedded in the form of a single chip, but is not limited thereto.

When the control module is accommodated in the cleaner main body 10, a driving voltage can be applied from the battery and divided into respective modules.

Hereinafter, the suction nozzle 100 will be described in detail.

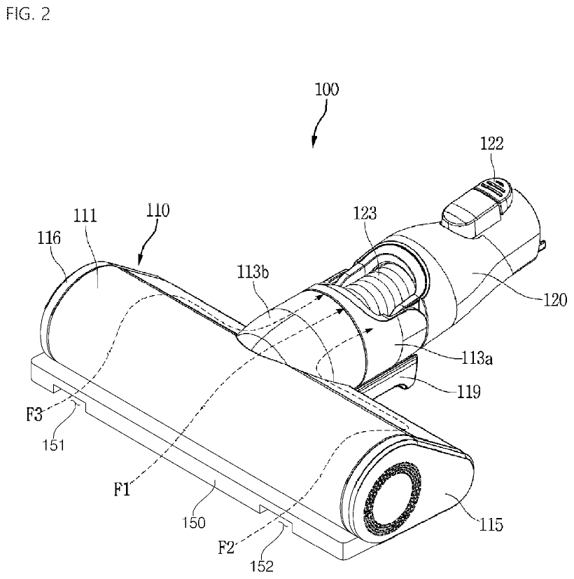

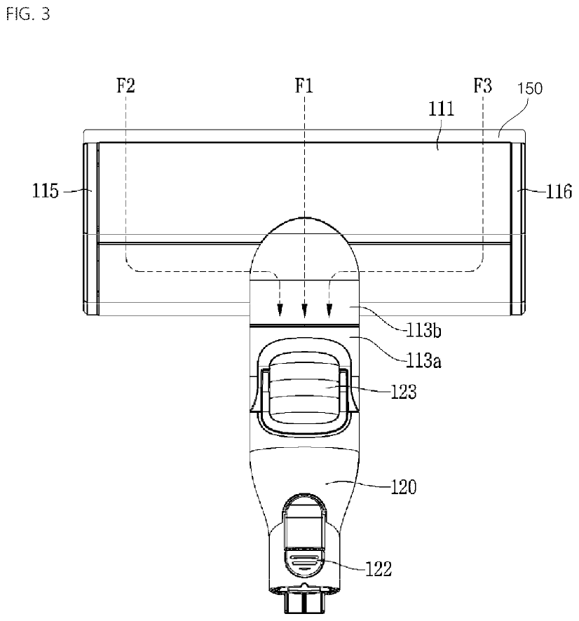

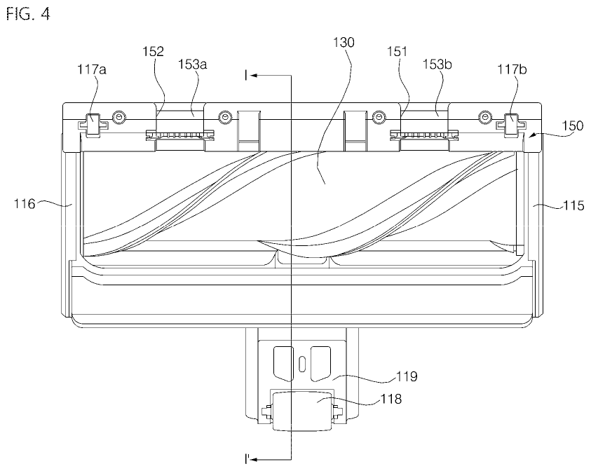

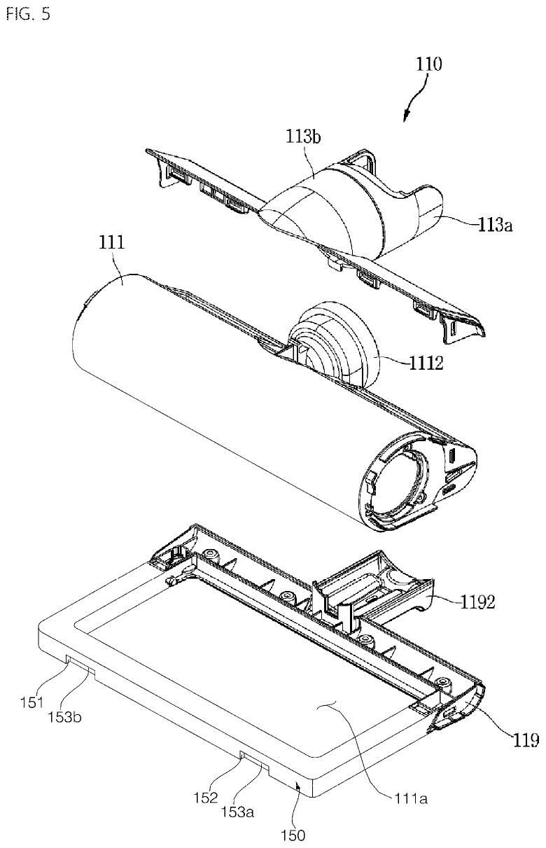

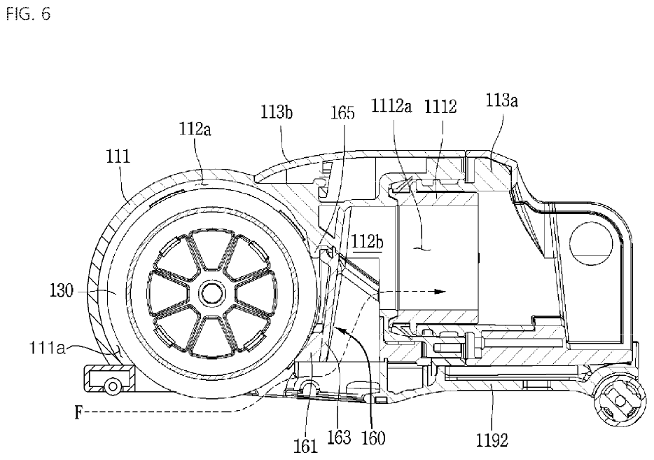

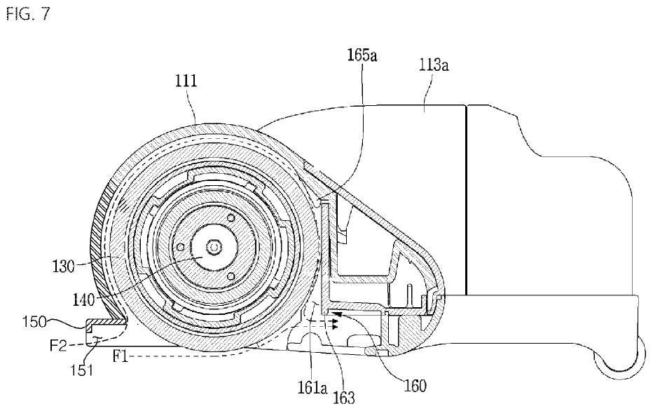

FIG. 2 is a perspective view showing the suction nozzle of FIG. 1, FIG. 3 is a top view showing the suction nozzle of FIG. 2, FIG. 4 is a bottom view of the suction nozzle of FIG. 1, FIG. 5 is an exploded perspective view showing the suction nozzle of FIG, FIG. 6 is a cross-sectional view showing the suction nozzle cut along line I-I′ of FIG. 4, and FIG. 7 is a cross-sectional view showing the suction nozzle cut along line II-II′ of FIG. 4.

Referring to FIGS. 2 to 7, the suction nozzle 100 includes a housing 110, a connection pipe 120, and a rotary cleaning unit 130.

In some implementations, the housing 110 includes a main body 111 forming a chamber 112 therein, and the main body 111 is closed toward the front and is coupled with a support member 119 formed below to form a space for accommodating the rotary cleaning unit 130 therein.

The housing 110 can further include a support member 119 provided under the main body 111. The support member 119 can support the main body 111.

The support member 119 forms a frame, and a lower opening 111a for suctioning in air containing contaminants can be formed. Air introduced through the lower opening 111a by the suction force generated in the cleaner main body 10 can move to the connection pipe 120 through the chamber 112.

The support member 119 includes a support frame 150 disposed under the main body 111, and an extension part 1192 extending from the support frame 150 and supporting connection members of the main body 111.

The support frame 150 is coupled to the bottom surface of the main body 111 to support the main body 111, as illustrated in FIG, and when the cross-sectional shape in the xy plane of the suction nozzle 100 is rectangle having a long length when viewed from the front, the support frame 150 can include two first bars extending along the x-axis and two second bars extending along the y-axis.

The first and second bars can have a predetermined thickness, can have a space therein, and can be connected to each other to form a rectangular frame.

In some examples, a first bar 119a facing the front substantially functions as a bumper of the suction nozzle 100, and at least one sub-inlet (here, 151 and 152) is formed in the front portion of the first bar 119a.

The sub-inlets 151 and 152 are passages for suctioning in large foreign substances, and the large foreign substances passing through the sub-inlets 151 and 152 move to the connection pipe at the rear through the chamber 120.

In some examples, at least two sub-inlets 151 and 152 can be provided, and can be formed in a rectangular shape having the same height.

The sub-inlets 151 and 152 are tunnels that are open to a predetermined height from the bottom surface, and extend through the first bar 119a to the lower opening 111a.

The height of the sub-inlets 151 and 152 can be at least 1.0 mm, but is not limited thereto.

Large foreign substances can be suctioned at the front of the lower portion of the support member 119 through the sub-inlets 151 and 152, and cover parts are formed to open and close the sub-inlets 151 and 152 depending on the floor condition in the inner space of the first bar 119a.

The driving of the cover part will be described later.

Front wheels 117a and 117b can be rotatably coupled to the lower surface of the rectangular support member 119 in the first bar 119a facing the front.

In addition, a rear wheel 118 can be rotatably coupled to the extension part 1192.

A rotating shaft of the rear wheel 118 can be disposed at the rear. Accordingly, since the stability of the housing 110 is improved, overturning of the housing 110 during cleaning can be prevented.

As described above, the lower opening 111a of the support member 119 is formed to extend from the bottom portion of the housing 110 in the right-left direction to secure a sufficient suction region.

The housing 110 can further include an inner pipe 1112 communicating with the lower opening 111a. Outside air can move to an inner flow path 1112a of the inner pipe 1112 through the lower opening 111a by the suction force generated in the cleaner main body 10.

The housing 110 can further include a drive unit for providing power to rotate the rotary cleaning unit 130. The drive unit can be inserted into one side of the rotary cleaning unit 130 to transmit power to the rotary cleaning unit 130.

The rotary cleaning unit 130 can be accommodated in the chamber 112 of the main body 111. At least a part of the rotary cleaning unit 130 can be exposed to the outside through the lower opening 111a. The rotary cleaning unit 130 can be rotated by a driving force transmitted through the drive unit and rubbed against the floor surface to remove contaminants. In addition, the outer circumferential surface of the rotary cleaning unit 130 can be made of a fabric or felt material such as cotton flannel. In this way, foreign substances such as dust accumulated on the floor surface can be effectively removed by being trapped on the outer circumferential surface of the rotary cleaning unit 130 when the rotary cleaning unit 130 rotates.

The main body 111 can cover the upper side of the rotary cleaning unit 130. In addition, the inner circumferential surface of the main body 111 can be formed in a curved shape to correspond to the outer circumferential shape of the rotary cleaning unit 130. In this way, the main body 111 can perform a function of preventing the foreign substances removed from the floor surface by the rotation of the rotary cleaning unit 130 from rising.

The housing 110 can further include side covers 115 and 116 for covering both sides of the chamber 112. The side covers 115 and 116 can be provided on both sides of the rotary cleaning unit 130.

The side covers 115 and 116 include a first side cover 115 provided on one side of the rotary cleaning unit 130 and a second side cover 116 provided on the other side of the rotary cleaning unit 130. The drive unit can be fixed to the first side cover 115.

The suction nozzle 100 further includes a rotation support provided on the second side cover 116 for rotatably supporting the rotary cleaning unit 130. The rotation support can be inserted into the other side of the rotary cleaning unit 130 to rotatably support the rotary cleaning unit 130.

The rotary cleaning unit 130 can rotate in a counterclockwise direction based on the cross-sectional view of FIG. 6. That is, the rotary cleaning unit 130 rotates to push the foreign substances the direction of the inner pipe 1112 at a contact point with the floor surface. Accordingly, the foreign substances removed from the floor surface by the rotary cleaning unit 130 are moved toward the inner pipe 1112 and are suctioned into the inner pipe 1112 by a suction force. Cleaning efficiency can be improved by rotating the rotary cleaning unit 130 backward based on the contact point with the floor surface.

A partition member 160 can be provided in the chamber 112. The partition member 160 can be formed to extend from an upper side to a lower side of the chamber of the housing 110.

The partition member 160 can be provided between the rotary cleaning unit 130 and the inner pipe 1112. Accordingly, the partition member 160 partitions the chamber 112 of the housing 110 into a first region 112a in which the rotary cleaning unit 130 is provided and a second region 112b in which the inner pipe 1112 is provided. As illustrated in FIG. 6, the first region 112a can be provided at a front portion of the chamber 112, and the second region 112b can be provided at a rear portion of the chamber 112.

The partition member 160 can include a first extension wall 161. The first extension wall 161 can extend such that the first extension wall 161 comes into contact with at least a part of the rotary cleaning unit 130. Therefore, when the rotary cleaning unit 130 rotates, the first extension wall 161 can rub against the rotary cleaning unit 130 to remove foreign substances attached to the rotary cleaning unit 130. In addition, the first extension wall 161 can extend along the rotating shaft of the rotary cleaning unit 130. That is, the contact point between the first extension wall 161 and the rotary cleaning unit 130 can be formed along the direction of the rotating shaft of the rotary cleaning unit 130. Therefore, the first extension wall 161 may not only remove foreign substances attached to the rotary cleaning unit 130, but also block foreign substances of the floor surface from introducing into the first region 112a of the chamber 112.

In addition, the first extension wall 161 can block hair, thread, or the like attached to the rotary cleaning unit 130 from introducing into the first region 112a of the chamber 112, and thus can prevent hair, thread, or the like from being tangled around the rotary cleaning unit 130. That is, the first extension wall 161 can perform an anti-tangle function.

The partition member 160 can include a second extension wall 165. Like the first extension wall 161, the second extension wall 165 can extend such that the first extension wall 161 comes into contact with at least a part of the rotary cleaning unit 130. Therefore, when the rotary cleaning unit 130 rotates, the second extension wall 165 can rub against the rotary cleaning unit 130 like the first extension wall 161 to remove foreign substances attached to the rotary cleaning unit 130. In some examples, the second extension wall 165 can have the same function as the first extension wall 161. Since the first extension wall 161 alone, without the second extension wall 165, can perform the function of removing foreign substances attached to the rotary cleaning unit 130, the second extension wall 165 may not be included in the configuration of the housing 110.

The second extension wall 165 can be disposed above the first extension wall 161. Therefore, the second extension wall 165 has a function of secondarily separating foreign substances that have not been separated by the first extension wall 161 in the rotary cleaning unit 130.

Hereinafter, flow of air in the housing 110 will be described.

A plurality of suction flow paths F1, F2, and F3 through which outside air is moved to the inner pipe of the main body 111 are formed in the main body 111 of the suction nozzle 100.

The plurality of suction flow paths F1, F2, and F3 include a lower flow path F1 formed under the rotary cleaning unit 130 and upper flow paths F2 and F3 formed above the rotary cleaning unit 130.

The lower flow path F1 is formed under the rotary cleaning unit 130. Specifically, starting from the rear opening 111a, the lower flow path F1 runs under the rotary cleaning unit 130 and through the second region 112b and is connected to the inner flow path 1112a.

The upper flow paths F2 and F3 are formed above the rotary cleaning unit 130. Specifically, the upper flow paths F2 and F3 run through the sub-inlets 151 and 152, over the rotary cleaning unit 130 in the first region 112a, and then through the second region 112b, and are connected to the inner flow path 1112a. Therefore, the upper flow paths F2 and F3 can join the lower flow path F1 in the second region 112b.

The upper flow paths F2 and F3 include a first upper flow path F2 formed on one side of the housing 110 and a second upper flow path F3 formed on the other side of the housing 110. Specifically, the first upper flow path F2 is disposed through the sub-inlet 152 adjacent to the first side cover 115, and the second upper flow path F3 is disposed through the sub-inlet 151 adjacent to the second side cover 116.

In order to form the first upper flow path F2, a first lower groove 161a can be formed in the first extension wall 161, and a first upper groove 165a can be formed in the second extension wall 165.

The first lower groove 161a is formed by recessing a part of an inner peripheral surface of the first extension wall 161, that is, a surface that abuts the rotary cleaning unit 130. In addition, the first lower groove 161a can be formed to extend along the circumferential direction of the rotary cleaning unit 130.

The first upper groove 165a is formed by recessing a part of an inner peripheral surface of the second extension wall 165, that is, a surface that abuts the rotary cleaning unit 130. In addition, the first upper groove 165a can be formed to extend along the circumferential direction of the rotary cleaning unit 130.

The first lower groove 161a is connected to the first upper groove part, and the first upper flow path F2 is formed along the first lower groove 161a and the first upper groove 165a. In some examples, when the second extension wall 165 is not provided in the suction nozzle 100, the first upper flow path F2 can be formed only by the first lower groove 161a.

As illustrated in FIG. 7, in the first upper flow path F2, the separation distance between the inner circumferential surface of the chamber 112 and the upper side of the rotary cleaning unit 130 can become narrower toward the inside of the chamber 112. Therefore, above the rotary cleaning unit 130, the closer to the lower opening 111a, the lower the flow speed of air, and thus discharge of foreign substances to the front by rotation of the rotary cleaning unit 130 can be suppressed.

Next, the second upper flow path F3 can have the same shape as the first upper flow path F2.

As in the first upper flow path F2, in the second upper flow path F3, the separation distance between the inner circumferential surface of the chamber 112 and the upper side of the rotary cleaning unit 130 can become narrower toward the inside of the chamber 112.

The partition member 160 can further include a third extension wall 163 coupled to the first extension wall 161. The third extension wall 163 can be coupled to a rear surface of the first extension wall 161 to support the first extension wall 161. A part of the third extension wall 163 can be exposed to the first region 112a of the chamber 112 by forming the first lower groove 161a and the second lower groove 161b in the first extension wall 161.

As described above, the housing 110 can be provided with the first upper flow path F2 provided above the rotary cleaning unit 130 as well as the lower flow path F1 provided below the rotary cleaning unit 130, thereby making it possible to efficiently cool the drive unit, and can be provided with the second upper flow path F3, thereby making it possible to effectively cool the rotation support 150. The connection pipe 120 can connect the housing 110 and the extension pipe 17 (see FIG. 1) to each other. That is, one side of the connection pipe 120 is connected to the housing 110, and the other side of the connection pipe 120 is connected to the extension pipe 17.

The connection pipe 120 can be provided with a detachable button 122 for operating the mechanical coupling with the extension pipe 17. The user can couple or separate the connection pipe 120 and the extension pipe 17 by operating the detachable button 122.

The connection pipe 120 can be rotatably connected to the housing 110. Specifically, the connection pipe 120 can be hinge-coupled to the first connection member 113a to be rotatable in the vertical direction.

The housing 110 can be provided with connection members 113a and 113b for hinge coupling with the connection pipe 120. The connection members 113a and 113b can be formed to surround the inner pipe 1112. The connection members 113a and 113b can include a first connection member 113a and a second connection member 113b directly connected to the connection pipe 120. One side of the second connection member 113b can be coupled to the first connection member 113a, and the other side of the second connection member 113b can be coupled to the main body 111.

The first connection member 113a can be rotatably connected to the second connection member 113b. Specifically, the first connection member 113a can be rotated about the longitudinal direction.

The suction nozzle 100 can further include an auxiliary hose 123 connecting the connection pipe 120 and the inner pipe 1112 of the housing 110. Accordingly, the air suctioned into the housing 110 can move to the cleaner main body 10 (see FIG. 1) passing through the auxiliary hose 123, the connection pipe 120, and the extension pipe 17 (see FIG. 1).

The auxiliary hose 123 can be made of a flexible material such that the connection pipe 120 can be rotated. In addition, the first connection member 113a can be shaped to surround at least a part of the auxiliary hose 123 to protect the auxiliary hose 123.

The suction nozzle 100 can further include front wheels 117a and 117b for movement during cleaning. The front wheels 117a and 117b can be rotatably provided on the lower surface of the first bar 150 of the support member 119 on the lower surface of the housing 110. In addition, the front wheels 117a and 117b can be provided in a pair on both sides of the lower opening 111a, respectively, and can be disposed behind the lower opening 111a.

The suction nozzle 100 can further include the rear wheel 118. The rear wheel 118 can be rotatably provided on the bottom surface of the housing 110 and can be disposed behind the front wheels 117a and 117b.

In some implementations, a drive unit for rotating the rotary cleaning unit 130 is coupled to the main body 111 of the housing 110. At least a part of the drive unit can be inserted into one side of the rotary cleaning unit 130.

The drive unit includes a motor for generating a driving force. The motor can include a blushless direct current (BLDC) motor. A printed circuit board (PCB) for controlling the motor can be provided on one side of the motor.

The drive unit can further include a gear unit for transmitting the power of the motor.

The drive unit further includes a shaft connected to the gear unit, and the shaft is connected to the rotary cleaning unit 130. The shaft can transmit a driving force transmitted through the gear unit to the rotary cleaning unit 130. This can make the rotary cleaning unit 130 rotate.

The drive unit periodically transmits, to the controller 140, a control signal for rotating the rotary cleaning unit 130, that is, an output current, through the driving of the motor.

The suction nozzle 100 includes the first bar 119a of the support member 119 functioning as a buffer at the front, and the first bar 119a includes at least one sub-inlet 151 and 152 as described above.

Although it is illustrated that two sub-inlets 151 and 152 are formed in FIGS. 2 to 7, the number of such sub-inlets 151 and 152 can vary in other implementations.

In some implementations, the suction nozzle 100 or the controller 140 can determine the floor condition on which cleaning is currently performed and further include cover parts 153a and 153b for closing or opening the sub-inlets 151 and 152 depending on the floor condition.

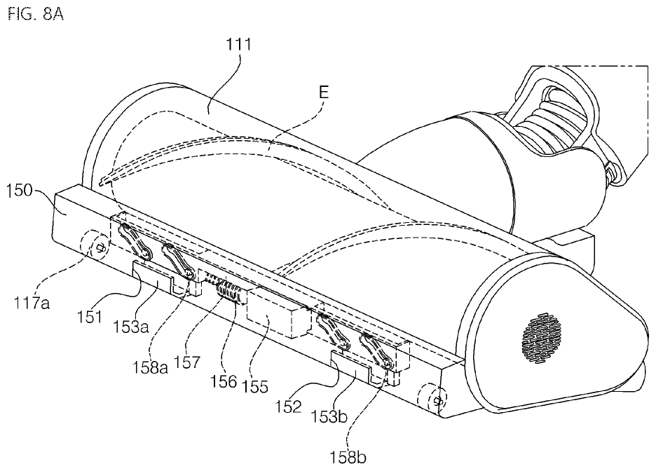

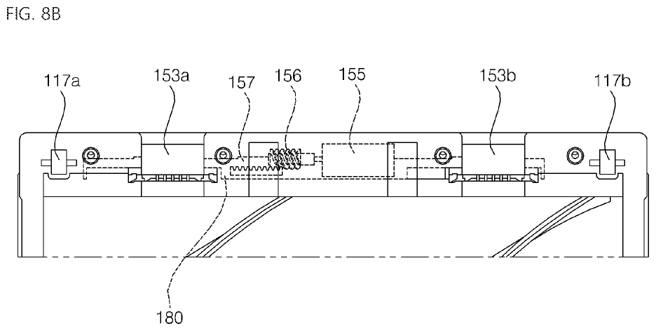

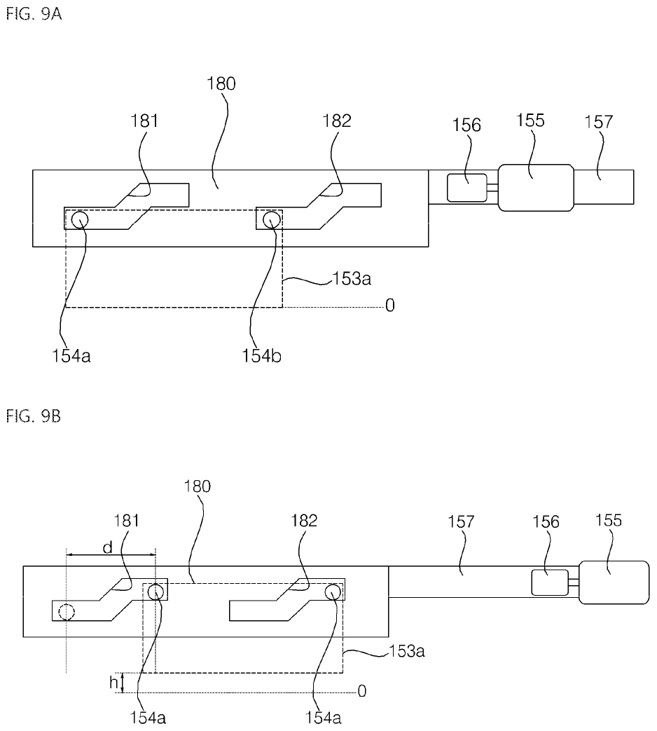

Hereinafter, the cover parts 153a and 153b of the present disclosure will be described with reference to FIGS. 8A to 9B.

FIGS. 8A and 8B are a perspective view and a part of a bottom view illustrating a structure of a lower frame of the suction nozzle 100, and FIGS. 9A and 9B are conceptual diagrams illustrating cover 153a and 153b of sub-inlets 151 and 152 and a driving module thereof.

First, referring to FIGS. 8A and 8B, the cover part includes n covers 153a and 153b for opening or closing each of the n sub-inlets 151 and 152.

In some implementations, n can be 2. In other implementations, the number of each of sub-inlets 151 and 152 can be 1, 3, 4, or other numbers.

The n covers 153a and 153b are devices having a shape corresponding to or the same as the shape of the sub-inlets 151 and 152, and can have a shape bent into a U shape as illustrated in FIGS. 8A and 8B, but are not limited thereto.

For instance, each of the covers 153a and 153b can be implemented as a hexahedral structure having an internal volume.

When each of the covers 153a and 153b is bent in a U shape as illustrated in FIG. 8A, each cover includes a first surface exposed to the front surface of the sub-inlets 151 and 152, a second surface bent from the first surface and forming a straight line with the lower surface of the support member 119, and a third surface bent from the second surface, arranged parallel to the first surface, and structurally coupled with a lever 180 of the rear surface.

The covers 153a and 153b can have protrusions 154a and 154b coupled to the lever 180 on the rear surface of the third surface, and the covers 153 and 153b can open or close the sub-inlets 151 and 152 depending on the relative position between the protrusions 154a and the 154b and the lever 180 by the movement of the protrusions 154a and 154b.

The cover parts 153a and 153b include a motor 155 driven according to a control command of the controller 140 to move the covers 153a and 153b.

The motor 155 can be accommodated in the central region of the first bar 119a as illustrated in FIG. 8A, and can be a small motor 155 to be accommodated in the central region of the first bar 119a.

For example, the motor 155 can be a small standard motor 155 having a width of 10 to 15 mm and a length of 20 to 40 mm, and the length of the shaft coupled with the gear can be formed very short.

The motor 155 can output a torque of 10N and a revolutions per minute (RPM) between 70 to 80. In some examples, the motor 155 can output other torque values.

The cover part further includes a gear unit connected to the shaft of the motor 155 to transmit power of the motor 155.

The gear unit is connected to the shaft of the motor 155 to change rotational motion into linear motion, and includes two gears 156 and 157.

That is, the gear unit includes a worm gear 156 that is connected to the shaft of the motor 155 and rotates with the driving of the motor 155, and a rack gear 157 that meshes with the worm gear 156 to the worm gear that advances and retreats along the x-axis with the rotational motion of the 156.

The rack gear 157 extends along the longitudinal direction of the first bar 119a, and advances or retreats along the x-axis of the first bar 119a with the rotation of the worm gear 156.

The cover part includes a lever that is connected to the rack gear 157 and moves the covers 153a and 153b in the vertical direction while advancing and retreating with the linear motion by advancing and retreating of the rack gear 157.

In some examples, the lever 180 can be integrally formed to raise or lower the first cover 153a and the second cover 153b at the same time, but a first lever 180 for raising the first cover 153a and a second lever 180 for raising the second cover 153b can be separated and fixed to the rack gear 157 at the same time.

Therefore, with the advance and retreat of the rack gear 157, the first lever 180 and the second lever 180 simultaneously advance or retreat, and thus the first cover 153a and the second cover 153b can be driven by the same operation.

The first lever 180 and the second lever 180 can have the same shape, and in each lever 180, guide grooves 181 and 182 are formed for moving protrusions 154a and 154b of the corresponding covers 153a and 153b as illustrated in FIGS. 8A and 8B.

Specifically, m protrusions 154a and 154b spaced apart from each other can be formed on the third surface of one cover 153a, and guide grooves 181 and 182 of the lever 180 are formed for each of the m protrusions 154a and 154b.

For example, when one cover 153a includes two protrusions 154a and 154b as illustrated in FIG. 8A, two guide grooves 181 and 182 for guiding two protrusions, respectively, are formed in the corresponding lever 180.

The guide grooves 181 and 182 guide a path for moving the cover 153a up and down, the protrusions 154a and 154b is coupled to the guide grooves 181 and 182, respectively, and the covers 153a and 153b move along the guide grooves 181 and 182 vertically.

To this end, each of the guide grooves 181 and 182 extends from a first level L1 to a second level L2, which is positioned higher than the first level L1, and is opened, as illustrated in FIGS. 9A and 9B. In some examples, as illustrated in FIG. 9A, the guide groove can be formed in three bent patterns, a first pattern starting from the first level L1 and maintaining the first level L1 for extension to the second level L2, a second pattern connected to the first pattern and inclined to the second level L2, and a third pattern connected to the second pattern and maintaining the second level L3, but the pattern is not limited thereto.

For example, the guide groove can be formed to have a curved shape from the first level L1 to the second level L2.

In some examples, for the two guide grooves 181 formed in one lever 180, the distance between the end of the first level L1 of one guide groove 181 and the end of the first level L1 of the other guide groove 182 is formed to match the distance between the two protrusions 154a and 154b of the cover 153a.

Therefore, when the two protrusions 154a and 154b of the cover 153a are coupled to the guide grooves 181 and 182, respectively, and move along the corresponding guide grooves 181 and 182, the covers 153a and 153b can move vertically while maintaining a horizontal state.

Specifically, the movement of the cover part is performed when the shaft of the motor 155 is rotated by operating the motor 155 according to the control command from the controller 140 and the worm gear 156 connected to the shift is rotated accordingly in a specific direction. In FIG. 9A, when the worm gear 156 is rotated, the rack gear 157 meshed with the worm gear 156 performs a linear motion to move forward.

With the linear motion of the rack gear 157, the lever 180, which is fixed to the rack gear 157, also performs a linear motion and thus advances to the left by d as illustrated in FIG. 9B.

By the forward motion of the rack gear 157 and the lever 180 along the x-axis, the protrusions 154a and 154b of the cover 153a, which has been located at the left end of the guide grooves 181 and 182, that is, at the end of the first level L1, are moved to the end of the third pattern of the second level L2 through the first pattern and the second pattern, along the guide grooves 181 and 182.

Therefore, as the protrusions 154a and 154b reach the second level L2, the height of the protrusions 154a and 154b of the cover 153a rises from the first level L1 to the second level L2, and thus the height of the entire covers 153a and 153b rises by a level difference h1.

The sub-inlets 151 and 152, which have been closed by the cover 153a, are opened below the cover 153a by the rising of the height.

Therefore, the gears 156 and 157 are driven by the drive of the motor 155, and as the lever 180 fixed to the gears 156 and 157 advances together, the covers 153a and 153b rise upwards, thereby opening the sub-inlets 151 and 152.

The movement of the cover 153a is performed on the plurality of covers 153a and 153b simultaneously to open the plurality of sub-inlets 151 and 152 simultaneously.

In some examples, when the motor 155 rotates in the opposite direction, the protrusions 154a and 154b of the covers 153a and 153b descend to the first level L1 as the lever retreats by the opposite motion of the worm gear 156 and the rack gear 157. Therefore, the covers 153a and 153b move downward to close the sub-inlets 151 and 152.

In this way, by controlling the rotation direction of the motor 155 according to the control command, the sub-inlets 151 and 152 are opened or closed through the covers 153a and 153b.

The open and close driving of the sub-inlets 151 and 152 as described above can be performed by the determination of a control module (e.g., the controller 140) located in the main body 10 of the cleaner 1.

Hereinafter, a control method of the controller 140 to open or close the sub-inlets 151 and 152 by periodically determining the floor condition will be described.

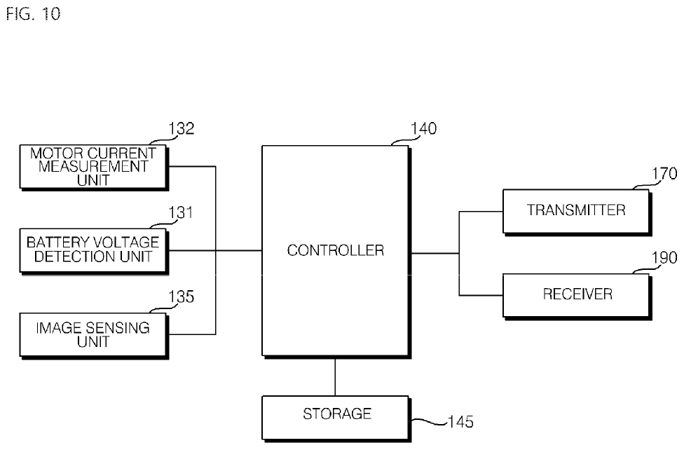

FIG. 10 is a block diagram of a control module for controlling covers 153 and 153b of a cleaner.

Referring to FIG. 10, the control module for controlling the covers 153a and 153b of the cleaner 1 is a functional block, and can only be functionally classified within one module; it can be implemented with a plurality of physically separated modules.

The control module of the cleaner 1 can have more accurate control efficiency through machine learning and deep learning by including an artificial intelligence engine.

The control module can include a plurality of sensors that detect surrounding conditions. The sensor can detect information outside the cleaner 1. The sensor detects a user around the cleaner 1. The sensor can detect objects around the cleaner 1.

The sensor can detect information about a cleaning area. The sensor can detect obstacles such as walls, furniture and cliffs on the traveling surface. The sensor can detect information about a ceiling. The sensor can include an object placed on the traveling surface and/or an external upper object. The external upper object can include a ceiling, a lower surface of furniture, or the like disposed in the upper direction of the cleaner 1.

The sensor can include an image sensing unit 135 that detects an image around it. The image sensing unit 135 can detect an image in a specific direction with respect to the cleaner 1. For example, the image sensing unit 135 can detect an image in front of the cleaner 1. The image sensing unit 135 photographs a traveling area, and can include a digital camera. The digital camera can include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP can generate a moving image including frames composed of still images, in addition to the still image.

In some examples, a battery voltage detection unit 131 for detecting the output voltage of the battery provided under the main body 10 is further included.

The battery can supply power for the overall operation of the cleaner 1 as well as the suction motor.

In addition, the cleaner 1 can further include a manipulation unit capable of inputting On/Off or various commands.

The cleaner 1 includes a storage 145 for storing various data. For example, various data for controlling the cleaner 1 can be recorded in the storage 145. The storage 145 can include a volatile or nonvolatile recording medium. The recording medium stores data that is readable by a microprocessor, and can include a hard disk drive (HDD), a solid state disk (SSD), a silicon disk drive (SDD), a read-only memory (ROM), a random-access memory (RAM), a compact disc ROM (CD-ROM), and a magnetic tape, a floppy disk, an optical data storage device, and the like.

The storage 145 can include an engine that performs artificial intelligence machine learning for controlling the opening and closing of the covers 153a and 153b, and the controller 140 can open and close the covers 153a and 153b depending on the engine.

The control module includes a motor current measurement unit 132 that reads the output current of the motor that rotates the rotary cleaning unit 130, processes it, and delivers it to the controller 140.

A transmitter 170 can transmit information on the cleaner to another cleaner or a central server. A receiver 190 can receive information from another cleaner or the central server. The information transmitted by the transmitter 170 or the information received by the receiver 190 can include configuration information of the cleaner.

In addition, the cleaner 1 can further include an input unit that receives On/Off or various commands, and the input unit can include a button, a key, or a touch type display. The input unit can include a microphone for voice recognition. In addition, the cleaner 1 can further include an output unit to notify a user of various types of information. The output unit can include a speaker and/or a display.

The cleaner 1 includes the controller 140 that processes and determines various types of information.

The controller 140 can perform information processing by driving the engine for controlling the opening and closing of the covers 153a and 153b depending on the floor condition while cleaning the floor.

The controller 140 can control the overall operation of the cleaner 1 through the control of various components (for example, the motor current measurement unit 132, battery voltage detection unit 121, the image sensing unit 135, the transmitter 170, and the receiver 190) constituting the cleaner 1.

The control method can be performed by the controller 140.

The present disclosure can be a control method of the cleaner 1, or can be a cleaner 1 including a controller 140 that performs the control method. The present disclosure can be a computer program including steps of the control method, or can be a recording medium on which a program for implementing the control method in a computer is recorded. The “recording medium” refer to a computer-readable recording medium and non-transitory memory. The present disclosure can be a mobile robot control system including both hardware and software. In some examples, the controller 140 can include an electric circuit, a processor, a microprocessor, or the like. In some examples, the controller 140 can include software programs or applications.

The controller 140 can include artificial neural networks (ANNs) in the form of software or hardware that have been trained to recognize at least one of properties of an object such as a user, a voice, a space attribute, an obstacle, and the like.

In some implementations, the cleaner 1 can include a deep neural network (DNN) such as a convolutional neural network (CNN), a recurrent neural network (RNN), a deep belief network (DBN), which are trained by machine learning and deep learning. For example, a structure of the deep neural network (DNN), such as the convolutional neural network (CNN), can be mounted in the controller 140 of the cleaner 1.

Usage-related data is data acquired by using the cleaner 1, and can correspond to usage history data, a detection signal acquired from a sensor, and the like.

The structure of the trained deep neural network (DNN) can receive input data for recognition, recognize attributes of people, objects, and spaces included in the input data, and output the result.

In addition, the structure of the trained deep neural network structure (DNN) can receive input data for recognition, and analyze and learn the usage-related data of the cleaner 1 to recognize usage patterns, usage environments, and the like.

In some implementations, data related to space, objects, and usage can be transmitted to a server through a communication unit.

The server can train the deep neural network (DNN) based on the received data, and then transmit the updated structure data of the deep neural network (DNN) to the artificial intelligence cleaner 1 for updating.

Accordingly, the cleaner 1 becomes more and more smart, and can provide a user experience (UX) that evolves as it is used.

The controller 140 can control the operation of the suction nozzle 100.

The controller 140 reads a plurality of detection signals, determines the current floor condition accordingly, and changes the suction force of the suction nozzle 100 according to the determination result.

This change of the suction force can be performed by opening and closing the sub-inlets 151 and 152 formed in the first bar 119a of the support member 119.

That is, on a hard floor having a smooth surface such as wood or tiles, the sub-inlets 151 and 152 are opened to induce suction of bulky foreign substances. For the large foreign substances, if sufficient space for suction is not secured, it is likely that the cleaner 1 moves around with the large foreign substance being pushed by the front thereof without suctioning in. At this time, when the sub-inlets 151 and 152 are opened, the large foreign substances are suctioned in through the sub-inlets 151 and 152, and the entire bottom surface of the suction nozzle 100 remains in close contact. Accordingly, the overall surface pressure does not drop significantly and no effective performance degradation occurs.

In some examples, on the soft floor such as carpets, the adhesion degree to the floor surface is reduced by the carpet fibers, and the surface pressure of the entire floor is very low.

Therefore, it is advantageous to close the sub-inlets 151 and 152 in order to increase the suction force and increase the adhesion degree to the floor surface.

Therefore, the controller 140 can periodically determine the current floor condition to determine the opening or closing of the sub-inlets 151 and 152.

Determination can be made based on a plurality of detection signals and information on conditions by performing machine learning or deep learning through an artificial intelligence deep neural network (DNN) and the like built in for determining the floor condition, and the accuracy can be gradually improved by continuously updating the previous result values.

The controller 140 can receive the output value of the suction motor of the main body 10 and receive it as suction force information. Alternatively, the controller 140 can detect the suction pressure of the connection part of the suction nozzle 100 and transmit the suction force information.

In addition, the controller 140 receives the detection signals of the sensors, specifically, the detection signals of the motor current measurement unit 132 and the battery voltage detection unit 131, and reads a control command value of the user.

The controller 140 can input the control command values of the motor current measurement unit 132 and the user as parameters to generate a condition function for the input parameters.

By performing artificial intelligence machine learning or deep learning based on the output value of the condition function and applying it to each of different models depending on the floor condition, the suction force value can be derived as an output value.

In some examples, the controller 140 determines the probability of the current floor condition, that is, whether the current floor condition is the hard floor condition or the soft floor condition by comparing the detected current suction force information with a value obtained by applying the model based on each floor condition.

That is, after deriving a value obtained by applying a first suction force model representing the hard floor and a value obtained by applying a second suction force model representing the soft floor, the probability that the current floor condition is the hard floor condition and the probability that the current floor condition is the soft floor condition can be calculated by comparing the current suction force information with the suction forces output from the models.

Comparing the probabilities, the probability equal to or greater than a threshold value and having a greater value can define the current floor condition.

Therefore, it is possible to accurately determine the current floor condition by applying a plurality of parameters in combination, which makes it possible to correctly determine the floor condition even in situations such as a temporary increase in the motor output current value of the rotary cleaning unit 130 due to some temporary failure.

When it is determined, depending on the floor condition determined described above, that the current floor condition is the soft floor state, that is, the floor is the carpet, the controller 140 can lower the cover 153a and 153b downwards and close the sub-inlets 151 and 152 by controlling the cover unit to drive the motor 155 of the cover part.

By closing the sub-inlets 151 and 152 as described above, the suction force can be improved, and by detecting the suction force improvement, determination can be made that the operation is correctly performed.

The controller 140 can change the suction force by controlling the opening and closing of the sub-inlets 151 and 152 depending on the floor condition while periodically performing the operation described above.

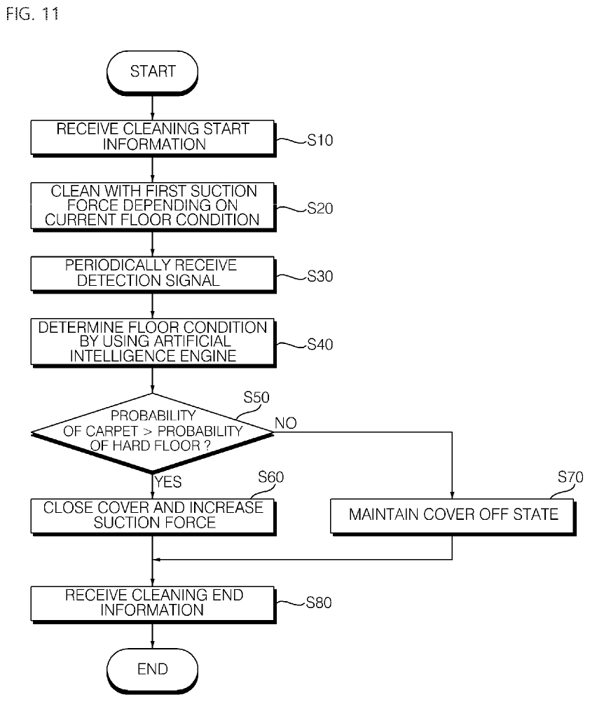

Hereinafter, a control operation of the controller 140 of the present disclosure will be described with reference to FIGS. 11 to 14D.

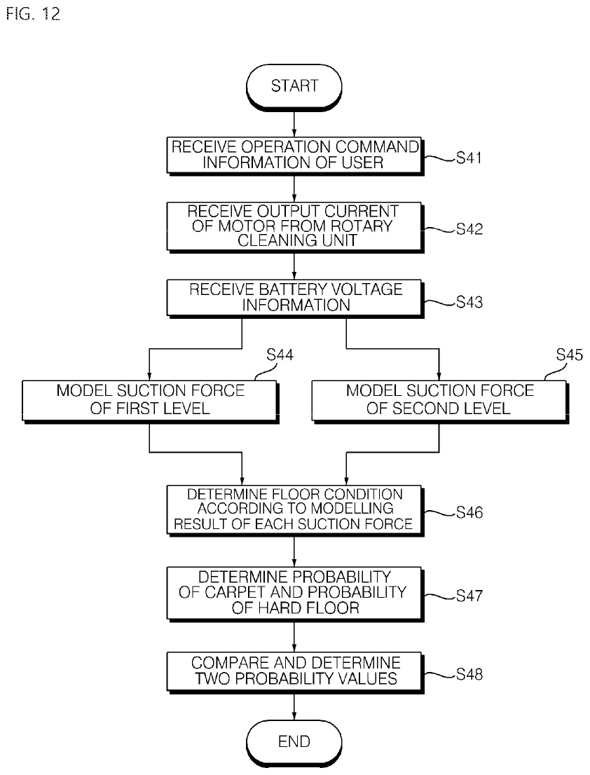

FIG. 11 is a flowchart illustrating a cover control of a cleaner, FIG. 12 is a flowchart illustrating a method for determining a floor condition of FIG. 11, and FIGS. 13A and 13B are schematic diagrams illustrating movement of a cover according to the control method of FIG. 10.

First, when a user starts the operation of the cleaner 1, the cleaner 1 receives the input cleaning start information and starts an operation (S10).

That is, cleaning starts with an initial suction force depending on the current floor condition (S10).

In some examples, the initial suction force can be generated according to a suction level designated by the user, and such a suction force can decrease depending on current floor condition (S20).

That is, when the floor condition is a condition of the hard floor such as wood or tiles, suction can be performed at the same level as the suction level designated by the user without lowering the effective suction force. However, when the floor condition is a condition of the soft floor such as a carpet, suction can be performed at a level in which the suction force is lower than that at the suction level designated by the user.

As described above, the cleaning of the suction nozzle 100 can be performed with the initial suction force.

Next, the controller 140 periodically receives a detection signal (S30).

The controller 140 reads a plurality of detection signals, determines the current floor condition accordingly, and changes the suction force of the suction nozzle 100 according to the determination result.

This change of the suction force can be performed by opening and closing the sub-inlets 151 and 152 formed in the first bar 119a of the support member 119.

In some examples, the period can be changed according to the setting of the user, and for example, the detection signal can be read in 0.5 to 3 seconds, for example, 0.8 seconds, which is within 1 second.

The read detection signal can include suction force information, user operation command information, battery information, and motor output current information.

The controller 140 can determine the floor condition based on a plurality of detection signals and information on conditions by performing machine learning or deep learning through an artificial intelligence deep neural network (DNN) and the like built in for determining the floor condition.

Specifically, referring to FIG. 12, the controller 140 can first receive operation command information of a user, and set initial information regarding a suction level based on the received information (S41).

In addition, specifically, the motor current measurement unit 132 reads the value of the output current of the rotating motor of the rotary cleaning unit 130 (S42).

The controller 140 can input control command values of the motor current measurement unit 132 and the user as parameters to generate a condition function for the input parameters.

Next, the controller 140 receives information on the output voltage of the battery, and applies the output voltage of the battery to the model of the condition of each floor as a variable (S43).

In addition, the controller 140 can implement modeling together by applying a floor condition determination value for a period before the current period as a variable.

By performing machine learning or deep learning of the artificial intelligence engine based on the output value of the condition function and the output voltage of the battery to drive the model depending on the floor condition, the suction force for each model can be calculated (S44, S45).

In some examples, the controller 140 derives the suction force value by inputting output value of each condition function and the output voltage of the battery as variables to the model for the hard floor.

In addition, the controller 140 derives the suction force value by inputting output value of each condition function and the output voltage of the battery as variables to the model for the soft floor.

That is, the model for the hard floor and the model for the soft floor are formed by applying a condition function according to various information and formulas, and the suction force value for each model can be derived by inputting the output value of the condition function and the output voltage of the battery as variables.

In some examples, the output voltage of the battery applied to each model can be operated to change the reference value of each model. That is, by lowering the reference value of the entire model when the output voltage of the battery is lower than the reference level, the error due to the output voltage drop of the battery can be eliminated.

Next, the controller 140 compares the suction force information and the suction force value derived for each model (S46).

The comparison can be made by deriving a matching probability between the suction force value for the model for the hard floor and the current suction force information and deriving a matching probability between the suction force value for the model for the soft floor and the current suction force information (S47).

By deriving the probability value of each floor condition, the probability of the hard floor and the probability of the soft floor are calculated.

Next, the controller 140 compares the magnitudes of the two probability values with each other to determine whether the current floor condition is the condition of the soft floor such as a carpet (S48).

Referring back to FIG. 11, when the probability of the carpet is greater than that of the hard floor for the current floor condition (S50), the controller 140 additionally determines whether the probability value of the current carpet is greater than a threshold value, and examines whether the corresponding probability is a valid value.

Accordingly, when the probability of the carpet is greater than that of the hard floor, and is equal to or greater than the threshold value, the current floor condition is defined as the carpet.

In some examples, the controller 140 transmits a control command to the motor 155 driving the cover part to drive the motor 155, and moves the lever 180 together by moving the worm gear 156 and the rack gear 157 by kinetic energy by the drive of the motor 155 (S60).

The covers 153a and 153b are lowered downwards while the lever 180 is moving by the above-mentioned movement in a state in which the two sub-inlets 151 and 152 are opened as illustrated in FIG. 13A.

As the covers 153a and 153b are lowered downwards, the sub-inlets 151 and 152 are closed as illustrated in FIG. 13B.

As the covers 153a and 153b are lowered downwards, the sub-inlets 151 and 152 are closed, and a suction area is concentrated in the lower opening 111a, which leads to an increase in the suction force.

Therefore, by concentrating the suction force to the lower portion when cleaning the carpet, it is possible to compensate for the decrease in the suction force due to the lower adhesion force by the fibers of the carpet.

In some examples, when the probability of the hard floor is greater than that of the carpet and it is also determined that the probability of the hard floor is equal to or greater than the threshold value and thus valid, the open state of the sub-inlets 151 and 152 on which the covers 153a and 153b are raised up is maintained (S70).

The suction force can be controlled by periodically determining the current floor condition and controlling the opening and closing of the sub-inlets 151 and 152, and upon receiving a cleaning end command from the user, the controller 140 of the cleaner 1 stops driving each of the motors and ends cleaning (S80).

In some examples, when determination is made as to the floor condition in the closed state of the sub-inlets 151 and 152 by the covers 153a and 153b that are lowered, which is the previous state, and it is determined that the floor condition is changed to the hard floor state, the operation of raising the covers 153 and 153b to reopen the sub-inlets 151 and 152 is performed.

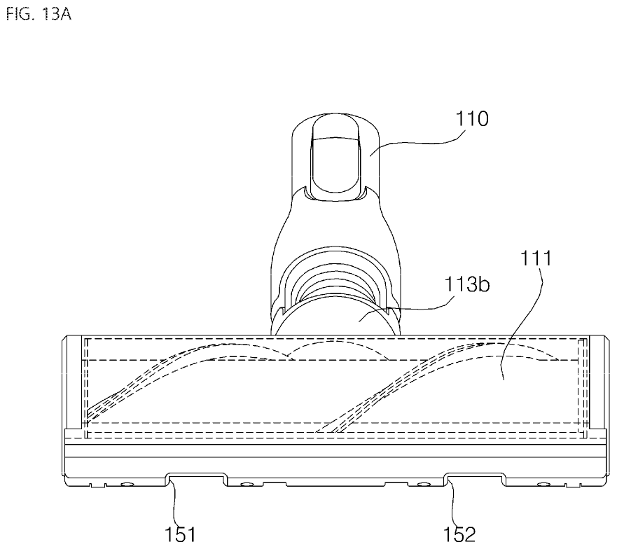

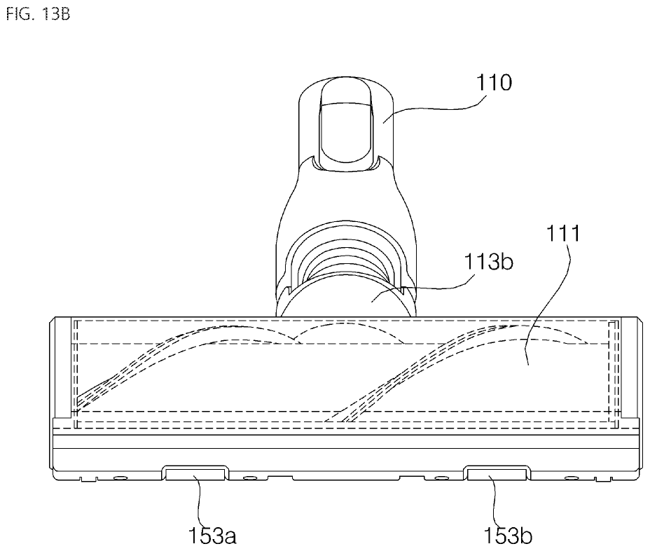

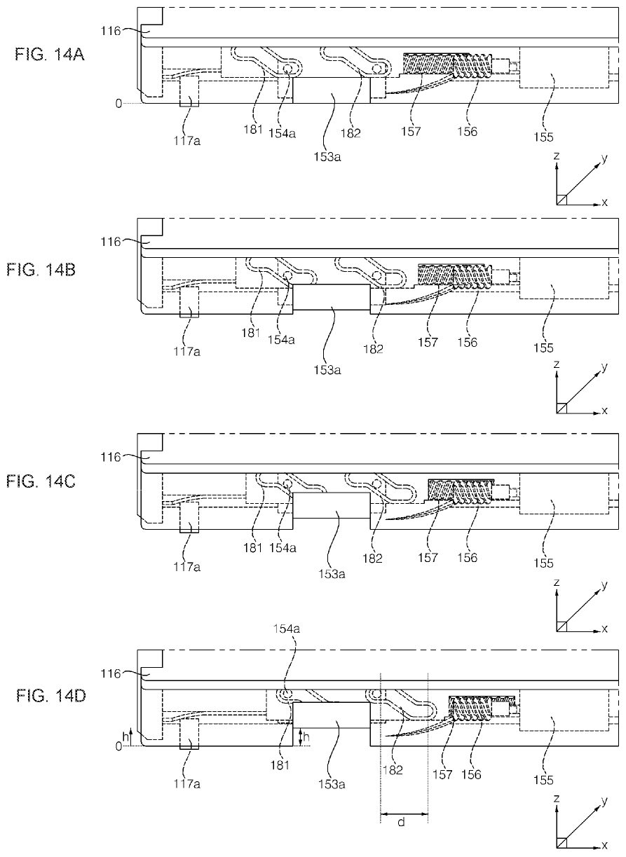

The opening operation of the sub-inlets 151 and 152 as described above can be described with reference to FIG. 14.

FIGS. 14A to 14D are diagrams of the first bar of FIG. 8A cut along to show the operation and driving of the cover parts 153a and 153b.

Referring to FIG. 14A, the current sub-inlets 151 and 152 start from a state in which they are closed by the covers 153a and 153b.

This is a state in which the current floor condition is determined as the soft floor such as a carpet, and the suction force is strongly concentrated due to low adhesion force of the suction nozzle 100 of the cleaner to the floor surface.

In some examples, when it is determined that the floor condition in the current period is shifted from the condition of the soft floor to the condition of the hard floor such as a tree or tile through periodic detection and operation of the artificial intelligence engine, the controller 140 transmits a control command to rotate the motor 155 of the cover part clockwise (forward).

The rotation makes the worm gear 156 rotate in the same direction, which, in turn, makes the rack gear 157 engaged with the worm gear 156 move linearly in a direction retreating along the x-axis.

In some examples, while the lever 180 fixed to the rack gear 157 moves together with the movement of the rack gear 157, the lever 180 can retreat a distance by d.

As the protrusions 154a and 154b are moving upward along the guide grooves 181 and 182 of the lever 180 by the retraction of the lever 180, the covers 153a and 153b fixed to the protrusions 154a and 154b rise upwards.

Therefore, the sub-inlets 151 and 152, which have been closed by the covers 153a and 153b, are opened to induce suction of large foreign substances.

That is, the current floor condition is the condition of the hard floor, that is, a condition having a smooth surface such as wood or tile, and it is determined that the adhesion force of the suction nozzle 100 of the cleaner to the floor surface is very high.

In some examples, since the opening of the sub-inlets 151 and 152 does not effectively lower the surface pressure that can affect high adhesion force, bulky foreign substances is induced to be suctioned in from the sub-inlets 151 and 152.

By periodically modelling the current floor condition by performing machine learning or deep learning through the artificial intelligence engine, it is possible to accurately determine the floor condition, and accordingly, by controlling the opening and closing of the sub-inlets 151 and 152 through the vertical movement of the covers 153a and 153b, it is possible to automatically adjust the opening and closing of the sub-inlets 151 and 152 without the user detecting the floor condition one by one and improving the suction force accordingly or manually adjusting the opening and closing of the sub-inlets 151 and 152.

In addition, it is possible to accurately determine the current floor condition by applying a plurality of parameters in combination, which makes it possible to correctly determine the floor condition even in situations such as a temporary increase in the motor output current value of the rotary cleaning unit 130 due to some temporary failure.

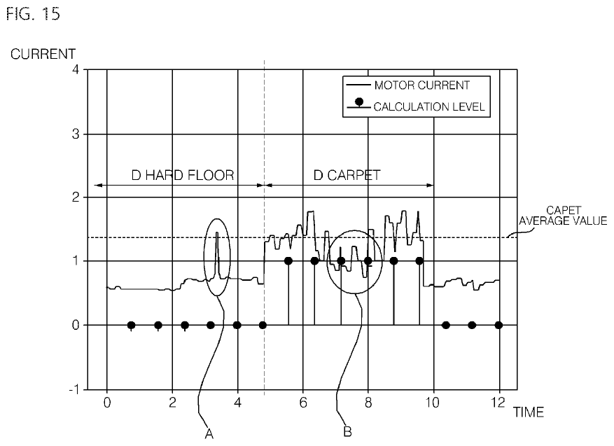

By performing modeling through the artificial intelligence engine, the controller 140 can obtain the result as illustrated in FIG. 15.

FIG. 15 illustrates a simulation result showing the result of determining the floor condition according to FIG. 11.

FIG. 15 illustrates examples of calculation levels when moving from the hard floor to the soft floor in the artificial intelligence modeling of the present disclosure.

For example, the motor output current of the rotary cleaning unit 130 can be represented as one variable. In some examples, in addition to the motor output current, the user's input command information, battery voltage information, and suction force information can be all applied as variables.

As illustrated in FIG. 15, in some implementations, an experiment is constructed with two types of floors, and floor detection performance depending on to each floor condition is checked.

In the related art, when the value of the motor output current of the rotary cleaning unit 130 is more than a predetermined threshold value, it is determined that the output current increases as the torque during rotation is largely applied by an obstacle. Therefore, in such a case, it is considered that there is an obstacle or that more torque is applied by fibers of the carpet.

According to the implementations of the present disclosure, by driving modeling through the artificial intelligence engine, not only the motor output current of the rotary cleaning unit 130, but also other sensing signals can be obtained in combination, and by reviewing them together with the previous result, that is, the history, it can be seen that only an increase in the torque of the rotary cleaning unit 130 does not derive a change in the determination of the floor condition.

For example, with respect to the motor output current value of the rotary cleaning unit 130, a region in which the motor output current value of the rotary cleaning unit 130 increases instantaneously exists in the region of the hard floor (D_HARDFLOOR), as in region A, and a region in which the motor output current value decreases to the hard floor level according to the stroke in the soft floor region (D_CARPET) is set as region B.

When the motor output current value of the rotary cleaning unit 130 is input to the modeling engine, the output calculated level is 0, the floor condition is recognized as the hard floor when the output calculation level is 0, and recognized as the carpet when the output calculation level is 1, by definition.

According to the setting described above, the calculation level output by the modeling engine, in some implementations, can have 0 in the hard floor region and 1 in the carpet region.

In some examples, even when the motor output current value of the rotary cleaning unit 130 is set to have a value that can cause a floor recognition error as in the region A and the region B, the sub-inlets 151 and 152 are continuously closed without improving the suction force by determining even the A region as a hard floor and without changing the suction force by determining even the B region as a carpet region, according to the combination of other variable.

By performing modeling through the artificial intelligence engine based on the simulation result as described above, even if various situations occur, it is possible to more accurately determine the floor condition, thereby making it possible to improve reliability.

Through the above solution, the suction force can be secured by the cover of the sub being opened and closed depending on the floor condition to secure the suction force.

In some implementations, when the cover is opened or closed, the cleaner can read a plurality of detection signals and perform artificial intelligence machine learning to accurately determine the floor condition.

In addition, the cover can be opened and closed automatically according to the determination result of the floor condition, and thus the cleaner, in some examples, may not include separate manual control of the cover.

In some implementations, in determining the floor condition, a plurality of parameters can be comprehensively reviewed, and the probability calculation for the current floor condition can be performed. Accordingly, operations of the cleaner can be more reliably controlled than a manual switching by the user or switching based only on a load change.

What is claimed is:

1. A cleaner comprising:
a cleaner main body comprising a suction motor disposed inside the cleaner main body and a handle disposed at an outside of the cleaner main body;
a suction nozzle connected to the cleaner main body, the suction nozzle comprising:
a housing that defines an open portion at a lower portion of the housing,
a rotary cleaning unit disposed inside the housing and exposed through the open portion of the housing, the rotary cleaning unit being configured to clean a surface based on rotating relative to the surface, and
a support member that is located below the housing and supports the housing, the support member having an open interior and at least one sub-inlet that is defined at a front surface of the support member and configured to receive foreign substances; and
a controller disposed at the cleaner main body, the controller being configured to:
determine a condition of the surface by driving an artificial intelligence engine, and
open and close the at least one sub-inlet based on the condition of the surface to thereby adjust a suction force of the cleaner.

2. The cleaner of claim 1, further comprising a rotating motor disposed in the housing and configured to rotate the rotary cleaning unit,
wherein the controller is configured to:
receive an output current of the rotating motor, and
determine the condition of the surface by driving the artificial intelligence engine based on the output current.

3. The cleaner of claim 1, wherein the controller is configured to:
determine a suction force value corresponding to at least one floor condition by driving the artificial intelligence engine through a suction force calculation model based on an operation command of a user and an output current of a rotating motor configured to rotate the rotary cleaning unit.

4. The cleaner of claim 1, wherein the controller comprises suction force calculation models corresponding to a hard floor and a soft floor, respectively, and
wherein the controller is configured to determine suction force values corresponding to the hard floor and the soft floor by driving the suction force calculation models.

5. The cleaner of claim 1, wherein the controller comprises suction force calculation models corresponding to a hard floor and a soft floor, and
wherein the controller is configured to:
determine suction force values corresponding to the hard floor and the soft floor by driving the suction force calculation models,
compare current suction force information including the suction force to the suction force values, and
based on comparing the current suction force information to the suction force values, determine a first probability that the condition of the surface corresponds to the hard floor and a second probability that the condition of the surface corresponds to the soft floor.

6. The cleaner of claim 5, wherein the controller is configured to close the at least one sub-inlet based on the second probability of the soft floor being greater than the first probability of the hard floor.

7. The cleaner of claim 5, wherein the controller is configured to:
apply an output voltage of a battery of the cleaner as a variable to the suction force calculation models to determine the suction force values corresponding to the hard floor and the soft floor.

8. The cleaner of claim 1, wherein the controller comprises suction force calculation models corresponding to a hard floor and a soft floor, the suction force calculation models being different from each other, and
wherein the controller is configured to:
determine suction force values corresponding to the hard floor and the soft floor by driving the artificial intelligence engine through the suction force calculation models based on an operation command of a user and an output current of a rotating motor configured to rotate the rotary cleaning unit.

9. The cleaner of claim 1, wherein the controller comprises suction force calculation models corresponding to a hard floor and a soft floor, the suction force calculation models being different from each other, and
wherein the controller is configured to:
determine a condition function by driving the artificial intelligence engine based on an operation command of a user and an output current of a rotating motor configured to rotate the rotary cleaning unit, and
determine suction force values corresponding to the hard floor and the soft floor by applying the condition function and a battery voltage to each of the suction force calculation models.

10. The cleaner of claim 9, wherein the controller is configured to determine the suction force values corresponding to the hard floor and the soft floor by changing reference values of the suction force calculation models according to the battery voltage.

11. The cleaner of claim 1, wherein the support member further comprises a cover part configured to open and close the at least one sub-inlet based on a control command of the controller.

12. A control method for a cleaner, the cleaner including a housing that defines an open portion at a lower portion of the housing, and a rotary cleaning unit that is disposed inside the housing, that is exposed through the open portion of the housing, and that is configured to clean a surface based on rotating relative to the surface, the control method comprising:
obtaining a plurality of detection signals of the cleaner;
determining a condition of the surface by driving an artificial intelligence engine based on the plurality of detection signals; and
adjusting a suction force of the cleaner by opening and closing at least a part of the lower portion of the housing according to the condition of the surface.

13. The control method of claim 12, wherein the housing defines at least one sub-inlet at a front surface of the lower portion of the housing, and the cleaner further includes a cover part that is configured to open and close the at least one sub-inlet, and
wherein adjusting the suction force is performed by controlling the cover part to open or close the at least one sub-inlet.

14. The control method of claim 12, wherein determining the condition of the surface comprises:
receiving an output current of a rotating motor that is disposed in the housing and configured to rotate the rotary cleaning unit, and
determining the condition of the surface based on the output current of the rotating motor.

15. The control method of claim 13, wherein determining the condition of the surface comprises:
receiving an operation command of a user and an output current value of a rotating motor configured to rotate the rotary cleaning unit;
determining a suction force value corresponding to at least one floor condition by driving a suction force calculation model based on the operation command of the user and the output current value of the rotating motor;
comparing current suction force information including the condition of the surface to the suction force value; and
based on comparing the current suction force information to the suction force value, determining a first probability that the condition of the surface corresponds to a hard floor and a second probability that the condition of the surface corresponds to a soft floor.

16. The control method of claim 15, wherein adjusting the suction force comprises closing the at least one sub-inlet by moving the cover part downward based on the second probability of the soft floor being greater than the first probability of the hard floor.

17. The control method of claim 12, wherein determining the condition of the surface comprises:
determining suction force values corresponding to a hard floor and a soft floor, respectively, by driving the artificial intelligence engine through a hard floor suction force calculation model and a soft floor suction force calculation model.

18. The control method of claim 12, wherein determining the condition of the surface comprises:
applying an output voltage of a battery of the cleaner as a variable to suction force calculation models; and
driving the artificial intelligence engine through the suction force calculation models to determine suction force values corresponding to a hard floor and a soft floor.

19. The control method of claim 12, wherein determining the condition of the surface comprises:
determining a condition function by driving the artificial intelligence engine based on an operation command of a user and an output current of a rotating motor configured to rotate the rotary cleaning unit; and
determining suction force values corresponding to a hard floor and a soft floor by applying the condition function and a battery voltage to each of suction force calculation models, the suction force calculation models being different from each other.

20. The control method of claim 19, wherein determining the condition of the surface further comprises:
changing reference values of the suction force calculation models according to the battery voltage to determine the suction force values corresponding to the hard floor and the soft floor.
